(19) United States
(12) Patent Application Publication
(10) Pub. No.: US 2024/0384369 A1
(43) Pub. Date: Nov. 21, 2024

(54) COMPOSITIONS AND METHODS FOR LITHIUM REMOVAL

(71) Applicant: UNIVERSITY OF SOUTH FLORIDA, Tampa, FL (US)

(72) Inventors: Nurettin Sahiner, Tampa, FL (US); Manoj Kumar Ram, Tampa, FL (US)

(21) Appl. No.: 18/667,882

(22) Filed: May 17, 2024

Related U.S. Application Data
(60) Provisional application No. 63/502,845, filed on May 17, 2023.

(51) Int. Cl. C22B 3/24; C08B 37/16; C08L 5/16; C22B 3/04; C22B 3/42; C22B 26/12; H01M 10/54

(52) U.S. Cl. CPC C22B 3/24; C08B 37/0012; C08L 5/16; C22B 3/04; C22B 3/42; C22B 26/12; C08L 2205/16; H01M 10/54

(57) ABSTRACT

The present disclosure provides a class of polymeric material comprising units with crown- ether- and cyclodextrin-based structure and preparation method thereof. Advantageously, the present polymeric material may be useful in lithium ion recovery with desirable reusability and/or metal ion selectivity.

### CROSS-REFERENCE TO RELATED APPLICATIONS

This application claims the benefit of U.S. Provisional Patent Application Ser. No. 63/502,845 filed on May 17, 2023, the content of which is incorporated by reference herein in its entirety.

### GOVERNMENT SUPPORT

Not Applicable

### BACKGROUND

The competitiveness in the vehicle industry and the clen energy market makes the battery industry one of the most strategically important technologies for the US. It was reported that the economy of the US market of lithium ion-batteries for commercial and passenger electric vehicles (EV), stationary storages including air travel are expected to increase considerably in the coming years. Lithium-based batteries for EVs expected to be dominant as it affords high energy, high power and long-lifetimes in comparison to other technologies. The lithium-ion batteries can be used in a wide range of electronic products, from mobile phones to EVs. Lithium-ion (Li-ion) batteries are non-toxic, and the increase in demand for such batteries is due to the efficient energy storage they provide, their light weight and the low level of CO₂ gas emissions as lithium-ion batteries have the highest charging density and is the lightest metal on earth. The use of lithium ions (Li⁺) ions in the battery technologies for developing EV industry increases the need for lithium in general. The source of lithium is scarce and generally obtained from mines with various technologies. Lithium in lithium alumina silicate structures can be found in minerals in various forms as such as spodumene and even in ion forms in sea, geothermal and salt waters and used in ceramics, medical devices, rockets as well as batteries. Various methods are commonly used to obtain lithium ion from brine such as precipitation, evaporator-crystallization, solvent-extraction, ion-exchange adsorption and so on. Among these methods, the most efficient and high selectivity for lithium can be accomplished by means of ion-exchange via adsorption method. The ion-exchange method can be readily used to recover lithium from salty lakes, geothermal and underground waters because this method has high lithium-ion selectivity and appropriate for environmental consideration e.g., does not cause any additional contamination. Therefore, the selective adsorption method is regarded as the most efficient method for Li-ion extraction and separation. On the other hand, other methods such as precipitation and evaporator-crystallization are only suitable for salty lake waters with a low Mg/Li ratio. Also, the solvent-extraction can be used in low-grade salt lake waters, but the excessive reagents used in the operation pose a great threat to the environment. More recently, Li-ion recycling process using thermal pre-treatment and water leaching from spent EV Li-ion batteries via waste utilization is proposed as well as new techniques of lithium ion recovery from pegmatites as lithium sources. It was reported that the concentration Li-ion in sea water is 0.178 mg.L⁻¹ with the total estimated amounts of 231 trillion tons. However, the presence of other interfering ions e.g., Na⁺, K⁺, Ca²⁺ etc. at high concentration make Li-ions uptake challenging and difficult.

Thus, there remains a need for alternative compositions and methods for efficient lithium-ion recovery.

### SUMMARY OF THE INVENTION

In one aspect, the present disclosure provides a polymeric material, which comprises: (A) a copolymer of crown ether and cyclodextrin; (B) a cryogel of poly-crown ether; (C) a fiber of poly-crown ether; (D) a microgel of poly-cyclodextrin; (E) a cryogel of poly-cyclodextrin; (F) a fiber of poly-cyclodextrin; or a combination thereof. In some embodiments, the polymeric material includes a microgel of poly-cyclodextrin, which is modified by crown ether.

In another aspect, the present disclosure provides of preparing a modified poly-cyclodextrin. The method can comprise:
converting a poly-cyclodextrin to an intermediate, wherein at least one cyclodextrin unit of the intermediate has a moiety of

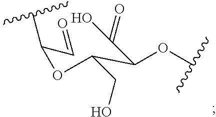 [SMILES: *OC(C(=O)O)C(CO)OC(*)C=O]

and
reacting the intermediate with a crown-ether derivative having a —OH group to produce the modified poly-cyclodextrin, where at least one cyclodextrin unit of the modified poly-cyclodextrin has a moiety of

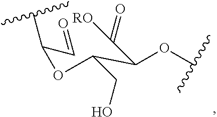

wherein R is the remainder of crown-ether derivative.

In another aspect, the present disclosure provides a modified poly cyclodextrin produced by the preparation method as described herein.

In yet another aspect, the present disclosure provides a method of recovering lithium ions from an aquatic source. The method may comprise contacting the aquatic source with the polymeric material as described herein or the modified poly cyclodextrin produced by the present preparation method, whereby the lithium ions form a complex with the polymeric material or the modified poly cyclodextrin. The method can further comprise isolating lithium ions from the complex.

### BRIEF DESCRIPTION OF THE DRAWINGS

Further objects, features and advantages of the present disclosure will become apparent from the following detailed description taken in conjunction with the accompanying figures showing illustrative embodiments of the present disclosure. Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows functionalization of 12-crown-4 ether (CE) and the preparation of p(CE) micro/nano particles and p(CE) cryogels.

FIG. 2 shows the preparation scheme of p(CD) micro/nanoparticles and cryogels and the SEM images of p(CDs)s.

FIG. 3 shows the SEM images of poly(α-Cyclodextrin) (p(α-CD), poly(β-Cyclodextrin) (p(β-CD)), or poly(γ-Cyclodextrin) (p(γ-CD)) microgels.

FIG. 4A shows the SEM images of p(α-CD), p(β-CD), p(γ-CD) cryogels. FIG. 4B shows the FT-IR spectrum of α-CD, β-CD, γ-CD oligomers and p(α-CD), p(β-CD), p(γ-CD) cryogels.

FIG. 5 shows (a) the adsorbed amount of Li⁺ ion, (b) the % removal of Li⁺ ion from 100 mL 500 ppm aqueous Li⁺ ion solutions, and (c) the adsorbed amount of Li⁺ ion from aqueous solutions in various concentration in 4 h by p(CD)-based microgels. Adsorption conditions: 50 mg adsorbent, 100 mL solution, room temperature, 300 rpm mixing rate.

FIG. 6 shows the metal ion adsorption studies of (a) p(α-CD), (b) p(β-CD), and (c) p(γ-CD) microgels in the presence of 500 ppm of Li⁺, Na⁺, K⁺, and Ca²⁺ ions. Adsorption conditions: 50 mg adsorbent, 100 mL solution, room temperature, 300 rpm mixing rate.

FIG. 7 illustrates the modification of p(β-CD) micro/nano particles. (a) treatment with NaIO₄, (b) oxidation reaction of aldehyde groups to carboxylic acids, (c) 2-Hydroxymethyl-12-crown-4 modification of p(β-CD) micro/nano particles, and (d) FT-IR spectrum of both p(β-CD)and M-p(β-CD) micro/nano particles.

FIG. 8 shows the comparison of FTIR spectrum of each form of p(β-CD) microgels during the modification process with 2-hydroxymethyl-12-crown ether-4.

FIG. 9 shows the comparison of (a) adsorbed amount of Li⁺ ion from 100 mL 500 ppm aqueous Li⁺ ion solution by p(β-CD) and M-p(β-CD) micro/nano particles, and (b) adsorbed amount of various metal ions from 100-mL mixture solutions at 500 ppm concentration each.

### DETAILED DESCRIPTION

The present disclosure relates to polymeric materials, such as those derived from crown ethers and cyclodextrin (CD) oligosaccharides, and their use in lithium recovery. In various embodiments, the capacity of these polymeric materials for Li⁺ ion adsorption in aqueous media are shown. Remarkably, the present polymeric materials can have significant selectivity toward lithium ion over other metal ions, thus offering an effective approach for lithium recovery and recycling.

### Composition

One aspect of the present disclosure provides a polymeric material. The polymeric material may comprise: (A) a copolymer of crown ether and cyclodextrin; (B) a cryogel of poly-crown ether; (C) a fiber of poly-crown ether; (D) a microgel of poly-cyclodextrin; (E) a cryogel of poly-cyclodextrin; (F) a fiber of poly-cyclodextrin; or a combination thereof.

Crown ethers (CE) are cyclic chemical compounds that consist of a ring containing several ether groups (R—O—R′). Common crown ethers include cyclic oligomers of ethylene oxide, the repeating unit being ethyleneoxy (i.e., —CH₂CH₂O—). Crown ethers that have internal diameter sizes similar to the size of Li⁺ ions may be employed for various functions including Li⁺ ion recovery. Suitable CE-based compositions for Li⁺ ion recovery include, but are not limited to, CE-imprinted polymers, CE-containing polymers, CE-containing fibers, and CE-containing membranes such as microporous membranes. In some embodiments, the composition comprises crown ethers with great selectivity for Li⁺ ions, such as 12-crown-4 ether. In some embodiments, the CE-based compositions can improve the safety and life span of Li-ion batteries.

“Poly-crown ether (p(CE))” refers to a polymer comprising repeating crown ether units crosslinked by various ratios of crosslinkers. Suitable cross linkers include, but are not limited to, methylene bis acrylamide (MBA), divinylbenzene (DVB) and divinyl sulfone (DVS). In some embodiments, crown ethers may be first functionalized using suitable monomers, such as acryloyl chloride, before undergoing polymerization and crosslinking reactions. In some embodiments, functionalized crown ethers may undergo emulsion polymerization, or cryopolymerization to form the poly-crown ethers. The poly-crown ether can be in various forms, including but not limited to, micro-and/or nanoparticles (such as microgels), cryogels, or fibers (such as microfibers). Microfibers may be prepared, for example, from poly-crown ethers using electrospinning techniques.

Cyclodextrins (CD) are cyclic oligosaccharides consisting of glucose units joined by α-1,4 glycosidic bonds. Cyclodextrins may vary in size based on the number of glucose units present. For example, the CDs may be α-, β-, or γ-CDs, which contain six, seven, and eight glucose units, respectively. CDs can self-assemble, cross-link, polymerize, and/or co-polymerize with other compounds. It has been reported that the sizes of Li⁺ ions in solvated forms are similar to the cavity diameter of some CDs, such as α-CD, β-CD, and γ-CD, with cavity diameters of 4.7-5.2,6.0-6.4, and 7.5-8.3 Å, respectively. Li⁺ ions have atomic radius of 152 pm (1.52 Å). In the hydrated states, Li⁺ ions are bigger and can fit in the cavity of CDs. It was reported that even though the ionic radius of Li⁺ is smaller than Na⁺, in hydrated states Lit has bigger size, e.g., 3.8 Å for Li⁺ versus 3.6 Å for Na⁺ ion. Therefore, CDs can be employed in the adsorption of Li⁺ ions in different aquatic environments. Suitable CD-based compositions for Li⁺ ion recovery include, but are not limited to, CD-imprinted polymers, CD-containing polymers, CD-containing fibers, and CD-containing membranes.

“Poly-cyclodextrin (p(CD))” refers to a polymer comprising repeating cyclodextrin units crosslinked by various ratios of crosslinkers. Suitable cross linkers include, but are not limited to, methylene bis Acrylamide (MBA), divinylbenzene (DVB) and divinyl sulfone (DVS). Poly-cyclodextrin may be of a variety of shapes and may behave like aggregates (e.g., particles). The poly-cyclodextrin can be in various forms, including but not limited to, micro-and/or nanoparticles (such as microgels), cryogels, or fibers (such as microfibers). Microfibers may be prepared, for example, from poly-cyclodextrins using electrospinning techniques.

Cryogels are unique porous structures, which are special types of hydrogel with interconnected super pores rendering rapid response to environmental variables such as pH, temperature, ionic strength etc., with high mechanical strength, and elasticity. Cryogels can be synthesized below freezing point of solvent, such as water. In such case, the obtained ice crystals act as porogen (pore forming agent) due to cross-linking/polymerization process carried out around the formed ice crystals. Cryogel can be superporous hydrogel networks that are prepared under freezing point of the solvents of the polymer and monomers (typically below 0° C.).

As used herein, “superporous” materials (such as superporous cryogels) may have pore sizes >50 nm and up to few hundreds of micrometers. The pore size of the present polymeric materials can be about 30 nm, about 40 nm, about 50 nm, about 60 nm, about 70 nm, about 80 nm, about 90 nm, about 100 nm, about 150 nm, about 200 nm, about 250 nm, about 300 nm, about 350 nm, about 400 nm, about 450 nm, about 50 nm, about 600 nm, about 700 nm, or about 800 nm.

In some embodiments, the polymeric material may comprise (A) a copolymer of crown ether and cyclodextrin. The co-polymer may be (A-1) a particle of the copolymer; (A-2) a cryogel of the copolymer; (A-3) a fiber of the copolymer, or a combination thereof. For example, the co-polymer may comprise p(CE-co-CD)) micro/nano particles at various CE/CD mole ratios. The co-polymer may comprise p(CE-co-CD) cryogels, such as p(CE-co-CD) superporous cryogels, at various CE/CD mole ratios. The co-polymer may also comprise p(CE-co-CD) fibers, such as p(CE-co-CD) microfibers, at various CE/CD mole ratios. The molar ratio of CD to CE in the copolymer as described herein can be about 1:100 to about 100:1. For example, the molar ratio of CD to CE in the copolymer can be about 1:80 to about 80:1, about 1:60 to about 60:1; about 1:40to about 40:1, or about 1:20 to about 20:1. In some embodiments, the molar ratio of CD to CE in the copolymer is about 1:100, about 1:80, about 1:60, about 1:40, about 1:20, about 1:10, about 1:5, about 1:1, about 5:1, about 10:1, about 20:1, about 40:1, about 60:1, about 80:1, or about 100:1.

In some embodiments, the polymeric material comprises (B) a cryogel of poly-crown ether. The poly-crown ether of the cryogel may be modified by a polymer of cyclodextrin. In some embodiments, the polymeric material comprises a cryogel of poly-crown ether, which further comprises poly-cyclodextrin particles embedded in the poly-crown ether at various extent. The cryogel of poly-crown ether as described herein may be superporous. The embedded pCD particles may be micro and/or nanoparticles, such as microgels.

In some embodiments, the polymeric material comprises (C) a fiber of poly-crown ether. The fiber can be a microfiber. The microfibers may be prepared, for example, by electrospinning. The poly-crown ether of the fiber may be modified by a polymer of cyclodextrin. In some embodiments, the polymeric material comprises a fiber of poly-crown ether, which further comprises poly-cyclodextrin particles embedded in the poly-crown ether at various extent. The fiber of pCE may be a microfiber. The embedded pCD particles may be micro and/or nanoparticles, such as microgels.

In some embodiments, the polymeric material comprises (D) a microgel of poly-cyclodextrin. The poly-cyclodextrin may be modified by crown ethers. For example, as least one of the glycose units in a CD repeating unit of the poly-cyclodextrin is substituted with a covalently attached crown ether. The crown ether may be attached to the glucose unit via any suitable covalent bond, such as ester, amide, —N═CH—, ether (—O—), or sulfide (—S—) bonds. Other known linkers also may be used for attaching the crown ether to the glucose unit. In some embodiments, the polymeric material comprises a microgel of poly-cyclodextrin, which is modified by crown ether. The microgel of poly-cyclodextrin as described herein may be superporous. The molar ratio of CD to CE in such CE-modified poly-cyclodextrin structures can be about 1:5 to about 100:1. For example, the molar ratio of CD to CE in the CE-modified poly-cyclodextrin structures can be about 1:4 to about 50:1, about 1:3 to about 50:1; about 1:2 to about 50:1, about 1:1 to about 50:1; about 1:5 to about 1:1; about 1:4 to about 1:1, about 1:3 to about 1:1, or about 1:2 to about 1:1.

In some embodiments, the polymeric material comprises (E) a cryogel of poly-cyclodextrin. The cryogel of poly-cyclodextrin can be modified. In some embodiments, the polymeric material comprises a cryogel of poly-cyclodextrin, which further comprises poly-crown ether particles embedded in the poly-cyclodextrin at various extent. The pCE particles may be micro and/or nanoparticles, such as microgels. The cryogel of poly-cyclodextrin may be superporous.

In some embodiments, the polymeric material comprises (F) a fiber of poly-cyclodextrin. The fiber of poly-cyclodextrin can be modified. In some embodiments, the polymeric material comprises a fiber of poly-cyclodextrin, which further comprises poly-crown ether particles embedded in the poly-cyclodextrin at various extent. The pCE particles may be micro and/or nanoparticles, such as microgels. The fiber of poly-cyclodextrin may be a microfiber.

The crown ether as used herein may be of any suitable size. In some embodiments, the crown ether is 12-crown-4 ether, 15-crown-5, 18-crown-6, or a derivative thereof.

The cyclodextrin as used herein may be of any suitable size. In some embodiments, the cyclodextrin is α-cyclodextrin, β-cyclodextrin, γ-cyclodextrin, or a derivative thereof.

In some embodiments, the polymeric material comprises a microgel of poly-cyclodextrin modified by crown ether. In some such embodiments, the poly-cyclodextrin may be poly-β-cyclodextrin and the crown ether may be 12-crown-4 ether.

In some such embodiments, the microgel of poly-cyclodextrin can include a repeating unit of

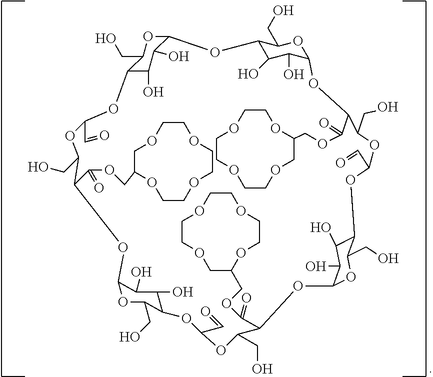

It is understood that CE-modified cyclodextrin repeating units with alternative structures are also included in the present disclosure. Any number of the glucose units (e.g., 1-5) in a CD repeating unit may be modified by the crown ether. In addition, any number of the CD repeating units in the poly-cyclodextrin polymer (e.g., 1 out of 100, 1 out of 50, or 1 out of 10 on average) may be modified by the crown ether.

As a nonlimiting example, the CE-modified glucose unit in the cyclodextrin repeating unit can have a structure of

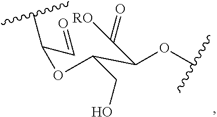

wherein R is the remainder of crown-ether derivative, such as

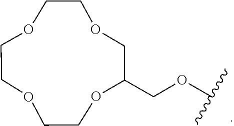 [SMILES: *OCC1COCCOCCOCCO1]

The crown ether or the cyclodextrin repeating units may be crosslinked by a crosslinker to form the copolymer of crown ether and cyclodextrin, the poly-crown ether, or the poly-cyclodextrin Crosslinkers of various sizes and structure may be used in the polymeric material disclosed herein. In some embodiments, the crosslinker is methylene bis Acrylamide (MBA), divinylbenzene (DVB), divinyl sulfone (DVS), or a combination thereof. In some embodiments, the crosslinker is divinyl sulfone (DVS).

The molar ratio of the crown ether and/or the cyclodextrin repeating units to the crosslinker may vary. For example, the molar ratio of the crown ether and/or the cyclodextrin repeating units to the crosslinker may be about 1:1 to about 1:5, about 1:1 to about 1:4, about 1:1 to about 1:3, about 1:1 to about 1:2, about 1:1 to about 1:1.5, or about 1:1 to about 1:1.1. In some embodiments, the molar ratio of the crown ether and/or the cyclodextrin repeating units to the crosslinker is about 1:1 to about 1:2.

### Preparation Method

Another aspect of the present disclosure provides a method of preparing a modified poly-cyclodextrin. The method may comprise:
converting a poly-cyclodextrin to an intermediate, wherein at least one cyclodextrin unit of the intermediate has a moiety of

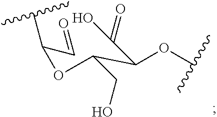 [SMILES: *OC(C(=O)O)C(CO)OC(*)C=O]

and
reacting the intermediate with a crown-ether derivative having a —OH group to produce the modified poly-cyclodextrin, where at least one cyclodextrin unit of the modified poly-cyclodextrin has a moiety of

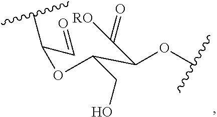

wherein R is the remainder of crown-ether derivative.

In some embodiments, the poly cyclodextrin may be poly-α-cyclodextrin, poly-β-cyclodextrin, poly-γ-cyclodextrin, or a derivative thereof.

In some embodiments, the crown ether derivative may be a derivative of 12-crown-4,a derivative of 15-crown-5, or a derivative of 18-crown-6. For example, the crow ether derivative attached to the pCD may be

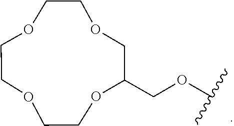 [SMILES: *OCC1COCCOCCOCCO1]

In some embodiments, converting the poly-cyclodextrin to the intermediate comprises treating the poly-cyclodextrin with an oxidizing agent. Oxidizing agents suitable for the oxidation of alcohols and/or aldehydes as commonly understood by one of ordinary skill in the art may be used. Suitable oxidizing agents include, but are not limited to, dichromate, CrO₃/pyridine, pyridinium chlorochromate (PCC), pyridinium dichromate (PDC), sodium periodate, Dess-Martin periodinane, dimethylsulfoxide (DMSO)/oxalyl chloride, CrO₃/H₂SO₄/acetone, aluminium isopropoxide/acetone, KMnO₄, and RuO₄. In some embodiments, the oxidizing agent is sodium periodate (NaIO₄), potassium permanganate (KMnO₄), or a combination thereof.

### Product

Another aspect of the present disclosure provides a modified poly-cyclodextrin produced by the preparation method as described herein.

In some embodiments, the modified poly-cyclodextrin has a repeating unit of

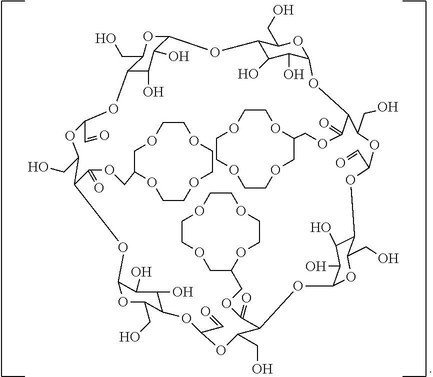

It is understood that the CE-modified cyclodextrin repeating units in the product produced by the present method can have alternative structures, in addition to the structure shown above. Any number of the glucose units (e.g., 1-5) in a CD repeating unit may be modified by the crown ether. In addition, any number of the CD repeating units in the poly-cyclodextrin polymer (e.g., 1 out of 100, 1 out of 50, or 1 out of 10 on average) may be modified by the crown ether.

As a nonlimiting example, the CE-modified glucose unit in the cyclodextrin repeating unit of the product produced by the present method can have a structure of

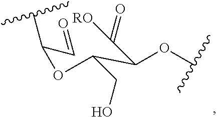

wherein R is the remainder of crown-ether derivative, such as

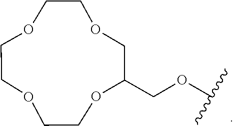 [SMILES: *OCC1COCCOCCOCCO1]

### Method of Use

The polymeric materials disclosed herein or prepared according to the methods disclosed herein may be utilized for recovering lithium ions, including those in a natural resource or a consumer product.

Another aspect of the present disclosure provides a method of recovering lithium ions from an aquatic source. The method may comprise:
contacting the aquatic source with the polymeric material as described herein or the modified poly cyclodextrin produced by the present preparation method, whereby the lithium ions form a complex with the polymeric material or the modified poly cyclodextrin; and
isolating lithium ions from the complex.

The lithium ions can be released from the complex, for example, by treatment of an acid. Acids suitable for releasing lithium ions include, but are not limited to, HCl, CH₃COOH, citric acid, HNO₃, and H₃PO₃.

In some embodiments, the method further comprises treating the complex with an acid prior to isolating lithium ions from the complex. In some such embodiments, the acid may comprise 0.1-1.0 M of hydrochloric acid, citric acid, acetic acid, or any combinations thereof.

The aquatic source may be allowed to contact the polymeric material for any suitable duration, depending on the desired amount of lithium ion adsorption, or the amount of time necessary to achieve equilibrium. In some embodiments, the method may comprise contacting the aquatic source with the polymeric material or the modified poly cyclodextrin for about 2 to about 12 hours, such as about 4 hours, about 6 hours, about 8 hours, or about 10 hours. In some embodiments, the method may comprise contacting the aquatic source with the polymeric material or the modified poly cyclodextrin for about 4 hours.

In some embodiments, the method may comprise contacting the aquatic source with the polymeric material or the modified poly cyclodextrin at room temperature. The temperature for forming the lithium-polymer complex may be adjusted based on the amount of lithium in the aquatic source and the polymeric material's capacity to complex with lithium.

In some embodiments, the polymeric material or the modified poly cyclodextrin may be re-used. For example, the polymeric material or the modified poly cyclodextrin may be reused for at least 1000 times, at least 500 times, at least 400 times, at least 300 times, at least 200 times, at least 100 times, at least 50 times, at least 20 times, at least 10 times, or at least 5 times.

Any aquatic sources containing lithium ions may be applicable to the methods disclosed herein. In some embodiments, the aquatic source comprises sea water, lake water, geothermal water, underground water, a lithium solution, or a combination thereof. The lithium solution may be a solution prepared from a lithium source for lithium recycle, such as a spent lithium battery. By the methods disclosed herein, lithium metal can be recovered from solid waste (e.g., batteries) as well.

Aquatic sources with various levels of lithium ion concentrations may be applicable to the methods disclosed herein. In some embodiments, the concentration of lithium ions in the aquatic source is about 100 ppm to about 2000 ppm. In some embodiments, the concentration of lithium ions in the aquatic source is about 100 ppm. In some embodiments, the concentration of lithium ions in the aquatic source is about 250 ppm. In some embodiments, the concentration of lithium ions in the aquatic source is about 500 ppm. In some embodiments, the concentration of lithium ions in the aquatic source is about 1000 ppm. In some embodiments, the concentration of lithium ions in the aquatic source is about 1500 ppm.

The methods disclosed herein may achieve great selectivity for lithium ion adsorption in comparison to alternative metal ions (e.g., Na⁺, K⁺, or Ca²⁺) in the same aquatic source. For example, the polymeric material may achieve at least 2-fold, at least 3-fold, at least 4-fold, at least 5-fold, at least 6-fold, at least 7-fold, at least 8-fold, at least 9-fold, at least 10-fold, or at least 15-fold selectivity for lithium ion adsorption comparing to Na⁺, K⁺, or Ca²⁺ ions in the same aquatic source. In some embodiments, the polymeric material achieves about 2.6-fold selectivity for lithium ion adsorption comparing to Na⁺ ions. In some embodiments, the polymeric material achieves about 4-fold selectivity for lithium ion adsorption comparing to K⁺ ions. In some embodiments, the polymeric material achieves about 7-fold selectivity for lithium ion adsorption comparing to Ca²⁺ ions.

Unless defined otherwise, all technical and scientific terms used herein have the same meaning as commonly understood by one of ordinary skill in the art to which the invention pertains. All definitions, as defined and used herein, should be understood to control over dictionary definitions, definitions in documents incorporated by reference, and/or ordinary meanings of the defined terms. As used herein, the terms “have,” “has,” “having,” “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter. As used herein, the singular forms “a,” “an,” and “the” include plural embodiments unless the context clearly dictates otherwise. The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9 to 1.1.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. All references, including publications, patent applications, and patents, cited herein are hereby incorporated by reference.

The present invention has been described in terms of one or more embodiments, and it should be appreciated that all possible equivalents, alternatives, variations, and modifications, aside from those expressly stated are within the scope of the invention.

### EXAMPLES

### Example 1. Crown Ether (CE) Based Polymers

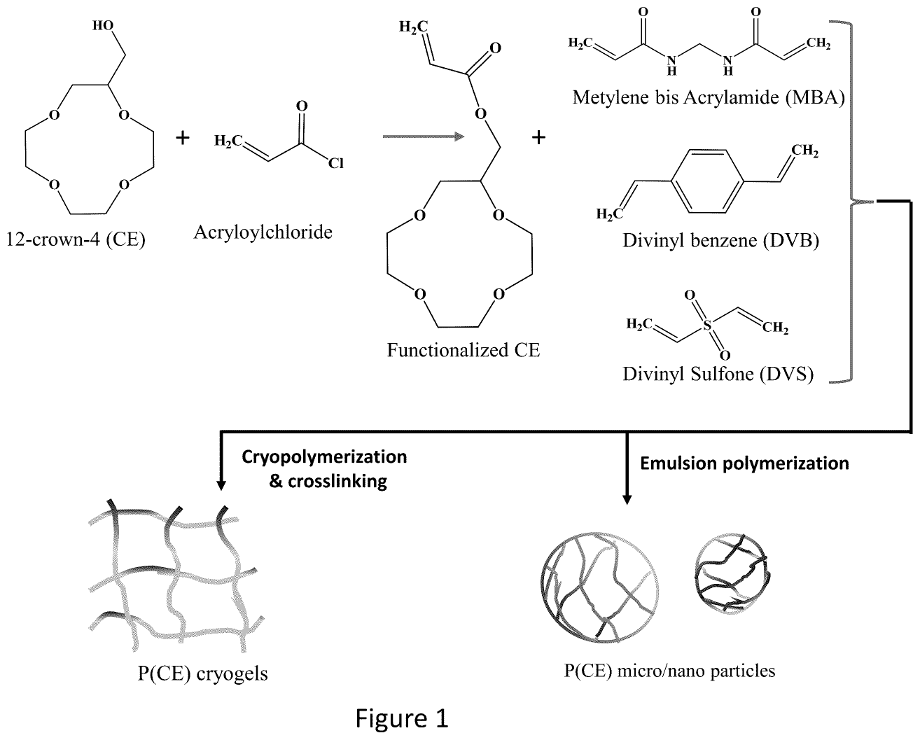

Crown ethers (CE) can be functionalized using suitable double bond containing monomers, such as acryloyl chloride, to obtain polymerizable CE, which can then be used in the polymerization and crosslinking reactions to produce poly crown ethers (pCE)). Functionalization of CE can be done by using acryloyl chloride as shown in FIG. 1.

The p(CE) micro/nano particle formation and p(CE) cryogel synthesis are also demonstrated in FIG. 1 using suitable crosslinker such as methylene bis Acrylamide (MBA), divinylbenzene (DVB) or divinyl sulfone (DVS).

The microfiber preparation from p(CE) can be performed using electrospinning techniques.

### Example 2 Cyclodextrins (CD) Based Micro/Nanoparticles

Materials. α-Cyclodextrin (α-CD, 98%, Spectrum Chemicals), β-Cyclodextrin (β-CD, 98%, Sigma), and γ-Cyclodextrin (γ-CD, >96%, TCI) as a precursor of synthesis of P(CD)-based microgels, and divinyl sulfone (DVS, 98%, Merck) was used as crosslinker. Dioctyl sulfosuccinate sodium salt (AOT, 96%, Acros) as a surfactant as well as isooctane (99.5%, Carlo Erba) was used as a solvent in preparation of P(CD)-based microgels. Acetone (96%, Bilkim), ethanol (96%, Bilkim), and double-distilled water (GFL 2018, Germany) were used in precipitation and purification of P(CD)-based microgels. Sodium hydroxide (NaOH, pellets ACS/Reag. Ph. Eur., VWR) was used to dissolve α-, β-, and γ-CD. Lithium chloride (LiCl, 99%, Carlo Erba), sodium chloride (NaCl, 99.5%, AFG Bioscience), potassium chloride (KCl, 99.5%, Merck), and calcium chloride (CaCl_{2,} 99%, Carlo Erba) were used as metal ion sources. Sodium periodate (NaIO₄), potassium permanganate (KMnO_{4,} 99%, Acros), sulfuric acid (98%, H₂SO₄, Carlo Erba), 1,1-carbonyldiimidazole (CDI, Reagent grade, Aldrich) 2-Hydroxymethyl-12-crown-4 (99%, Sigma Aldrich), and dimethyl sulfoxide (DMSO, ≥99.5%, Sigma-Aldrich) were used for the modification of p(β-CD) microgels.

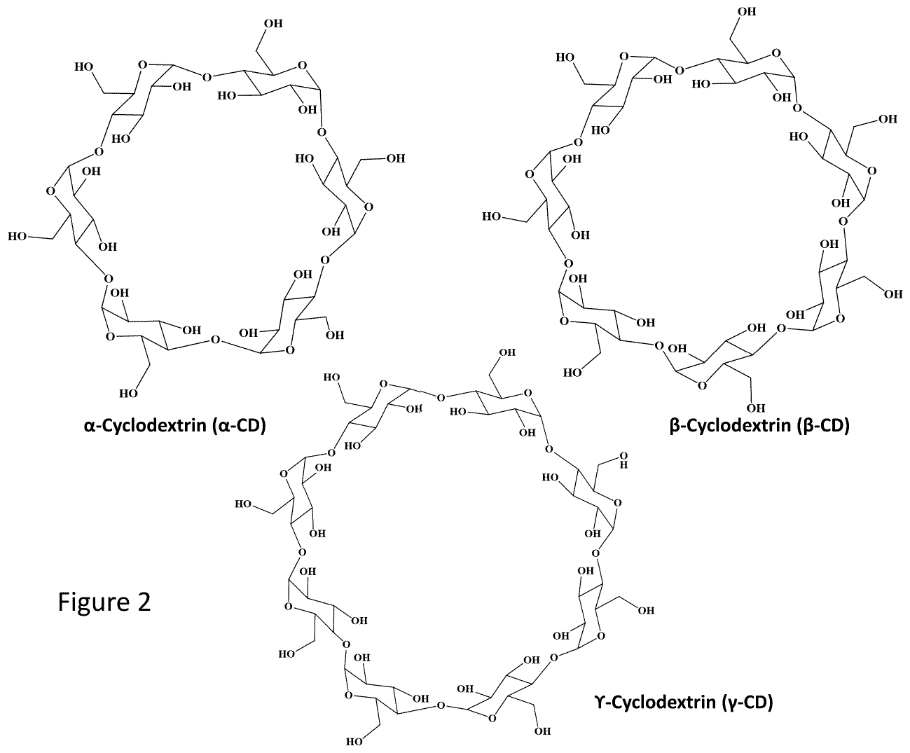

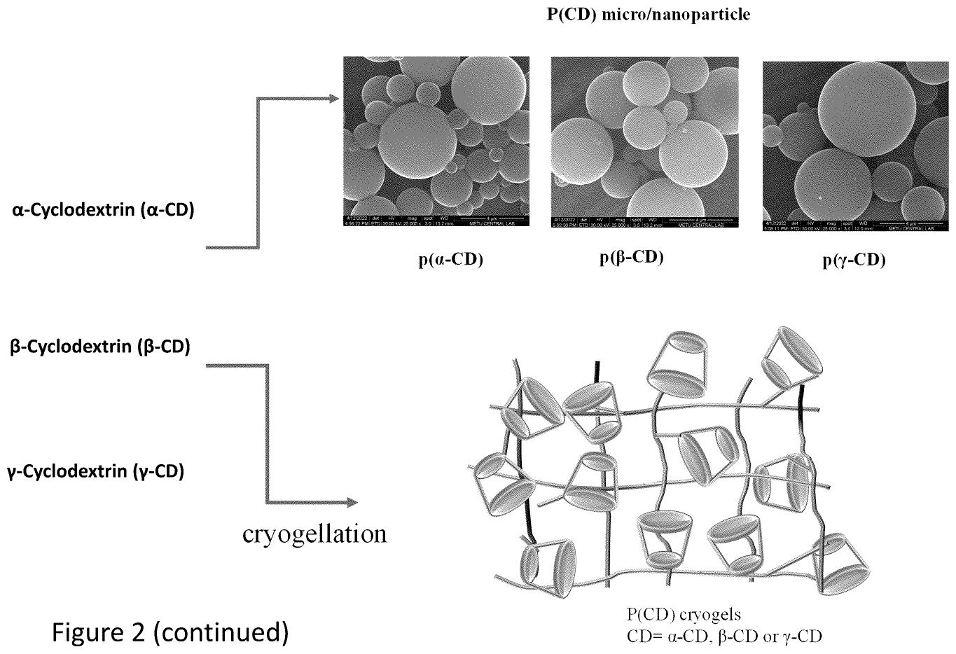

Synthetic Procedure. The preparation of micro/nanoparticles of representative CDs is shown in FIG. 2. Synthesis of p(α-CD), p(β-CD), and p(γ-CD) microgels were carried out by following the literature procedure. See Demirci et al. (“Chemically Cross-Linked Poly (β-Cyclodextrin) Particles as Promising Drug Delivery Materials”, ACS Appl. Polym. Mater. 3 (2021) 6238-6251) and Yilmaz et al. (“ESI-IM-MS characterization of cyclodextrin complexes and their chemically cross-linked alpha (α-), beta (β-) and gamma (γ-) cyclodextrin particles as promising drug delivery materials with improved bioavailability”, Colloids Surfaces B Biointerfaces. 230 (2023) 113522), the contents of which are incorporated here by reference in entirety. In brief, 0.5 mL of prepared α-, β-, and γ-CD solutions in 5 mL 0.25 M NaOH at 100 mg/mL concentrations were added into 30 mL 0.2 M AOT/isooctane solution under continuous mixing at 1000 rpm and room temperature, separately. After that, the crosslinker, DVS in 100% mole ratio according to the stoichiometric mole ratio of C6 hydroxyl groups on α-, β-, and γ-CD, was added to mixture and stirred at room temperature for 2 h. Finally, the prepared p(α-CD), p(β-CD), and p(γ-CD) microgels were precipitated in excess amount of acetone, and collected via centrifugation at 10000 rpm for 10 min. The collected p(α-CD), p(β-CD), and p(γ-CD) microgels were washed with acetone (x2), acetone-water (50:50 v:v, x2), ethanol (x2), and acetone (x2), respectively to remove unreacted reagents and surfactants. The washed p(α-CD), p(β-CD), and p(γ-CD) microgels were dried via heat gun and stored in usage tubes for further usages.

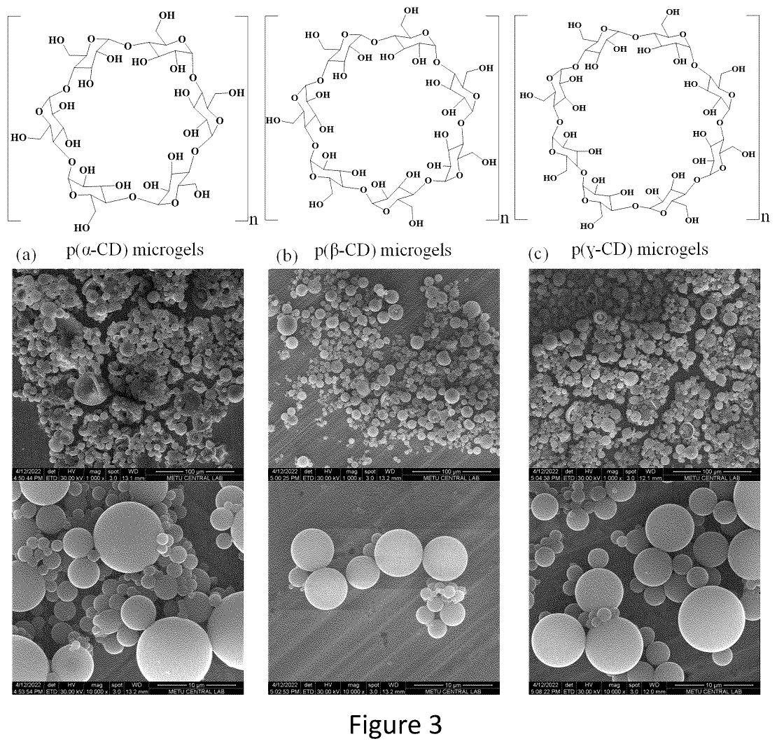

Characterization. The chemical structures of CD molecules and SEM images of the prepared p(α-CD), p(β-CD), and p(γ-CD) microgels are shown in FIG. 3, panels (a), (b), and (c) respectively. The size of microgels were observed from a few micrometers to ten micrometers as can be seen in SEM images (FIG. 3). On the other hand, the crosslinking reactions were confirmed with the observing S═O and O—S—O symmetric and asymmetric stretching peaks around 1020, 1290, and 1360 cm⁻¹, respectively, for all p(CD)-based microgels.

The thermal stabilities of prepared p(α-CD), p(β-CD), and p(γ-CD) microgels were determined as almost stable up to almost 300° C. via TGA measurements. Also, the zeta potentials of prepared p(α-CD), p(β-CD), and p(γ-CD) microgels were reported as −26.0±0.8 mV, −29.5±0.8 mV, −22.3±0.8 mV, respectively, and the isoelectric point for p(CD)-based microgels were determined at around pH 1.3.

### Example 3. Cyclodextrins (CD) Based Cryogels

Materials. CDs, α-CD (98%, spectrum chemical MFG CORP), β-CD (minimum 98%, Sigma), γ-CD (>%99, TCI), divinyl sul-fone (DVS, >96.0%, TCI), sodium hydroxide pellets (AFG Bioscience, USA) were used as received in the prepara-tion of CD cryogels. For the biocompatibility analysis, the L929 cell line (SAP Institute, Ankara, Turkey) was used. L-Glutamine supplemented Dulbecco's Modified Eagle's Medium (DMEM, PanBiontech, AidenBach, Germany) with 4500 mg/L glucose and 3.7 g/L sodium pyruvate was purchased. Fetal bovine serum (FBS inactivated, PanBiontech, AidenBach, Germany), and Ca/Mg-free trypsin/EDTA (PanBiontech, AidenBach, Germany) were used as received. In the cytotoxicity assay, MTT agent (Thiazolyl blue tetrazolium bromide) (neoFroxx, Einhau-sen, Germany) was used as received. Trypan blue solu-tion (0.5%, Biological Industries, Bet-Haemek, Israel) and dimethyl sulfoxide (DMSO/sulfinylbismethane, 99.9%, Carlo-Erba, Val-de-Reuil, France) were also used as received. Bisphenol A (BPA, Sigma-Aldrich, 97%) and Curcumin (CUR, Sigma-Aldrich) were used as received. Ultra-pure deionized water was obtained from a Milli-QDirect-Q 3 UV water purification system (Merck).

Synthetic Procedure. The preparation of cryogels of representative CDs is shown in FIG. 2. The cryogels of p(α-CD), p(β-CD), and p(γ-CD)were synthesized according to the procedure reported in Ari et al. (“Superporous poly (β-Cyclodextrin) cryogels as promising materials for simultancous delivery of both hydrophilic and hydrophobic drugs”, Eur. Polym. J. 2022, 176, 111399) and Yilmaz et al. (“Super porous α-, β-, γ-cyclodextrin cryogels with high active agent loading and controllable release profiles”, J. Appl. Polym. Sci. 2024, 141(3), e54822), the contents of which are incorporated by reference in entirety. Briefly, the synthesis of super porous CD-based cryo-gels was carried out via the cryo-crosslinking method. Initially, 0.5 g of α, β, γ-CDs oligosaccharides were weighed, and dissolved in a 5 mL of 0.25 M NaOH solution separately in vials. Then, the vials were placed at −20° C. for 5 min for cooling. Next, the chemical crosslinker, DVS was added into CD solutions at 150%, 100%, and 125% mole ratios with respect to α-, β-, and γ-CD oligomers, respectively. After vortex mixing for 1 min, the cryogel precursors were transferred into plastic tubes (0.6 cm inner diameter) and placed into a deep freezer at −20° C. for 24 h for cryo-crosslinking. After this period, prepared super porous cryogels were cut about 1 cm lengths and placed in DI water in a 100 mL beaker to wash, and wash water was replaced every 2 h three times to eliminate unreacted molecules. The cleaned super porous p(CD) cryogels were then dried using a freeze-dryer.

Characterization. Scanning electron microscopy (SEM, Quanta 400F Field Emission) analyses of p(CD) cryogels were performed for the dried CD cryogels that were placed in SEM stubs and coated with palladium/gold in a few nm under a high vacuum and the images were visualized at 20.0 kV operating voltage. Swelling tests of p(CD) cryogels were performed in DI water.

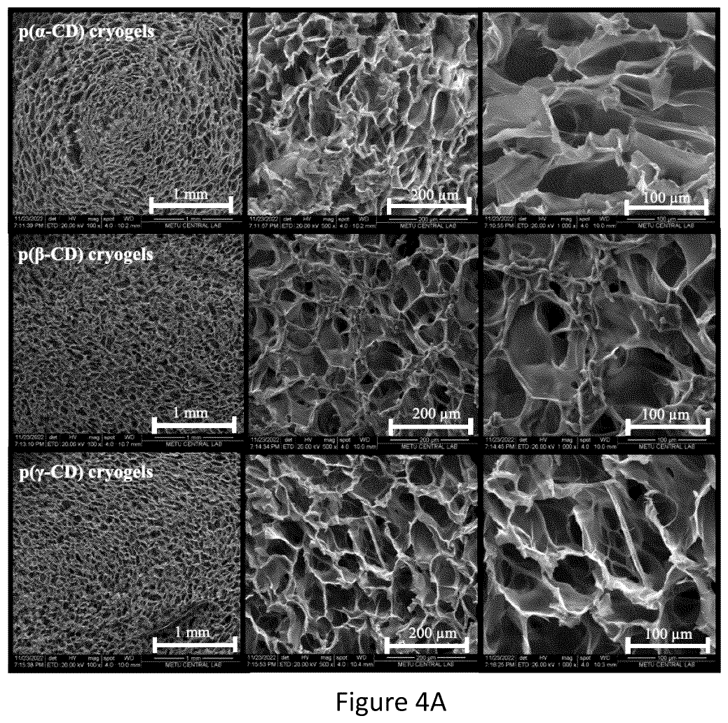

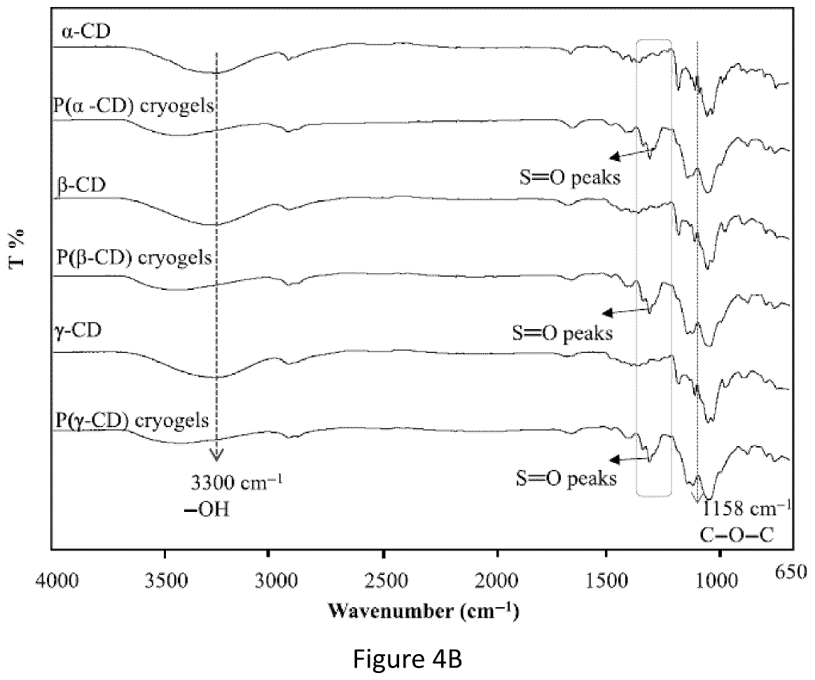

In FIG. 4A, the SEM images of the p(CD) cryogels are also zoomed in at different magnifications of p(α-CD), p(β-CD), and p(γ-CD) cryogels from left to right. It is apparent that the pore sizes of all p(CD) cryogels estimated from randomly selected pores are in the range of 5-100 μm. Also, it is clear from FIG. 4A that the prepared CD-based cryogels possessed interconnected macropores with homogeneous pore distribution regard-less of the nature of the CDs. It can be seen from the SEM images that no particular difference in SEM images of p(α-CD), p(β-CD), and p(γ-CD) cryogels was observed, and all three of the super porous cryogels exhibited both smaller and larger pores, however, the pore distribution of all the cryogels are homogeneous.

The cross-linking of CD oligosaccharides with cross-linker DVS was checked by FT-IR analysis and the FT-IR spectra of all CDs and their corresponding cryogels are given in FIG. 4B. In FIG. 4B, characteristic peaks of CD units were affirmed at 3300 cm⁻¹ attributed to hydroxyl stretching, and the peak at 2930 cm⁻¹ due to symmetric and asymmetric CH₂ stretching vibrations, and the peaks in 1300-1400 cm⁻¹ range attributed to C—H stretching vibrations, and the peaks at 1158 cm⁻¹ ascribed for C—O—C vibrations. The crosslinking reaction between hydroxyl groups of CD and vinyl groups of DVS could be confirmed because of the new peaks appearing at 1120, 1292, and 1372 cm⁻¹. These peaks can be attributed to specific S═O, and O—S—O stretching peaks due to the sulfone groups within p(CD) cryogels. These results supported that p(α-CD), p(β-CD), and p(γ-CD) cryogels were synthesized successfully using DVS in a single step at 150%, 100%, and 125% mole ratio of α-CD, β-CD, and γ-CD molecules, respectively.

To further corroborate p(CD) cryogel formation as well as to find the cross-linking yield, elemental analysis of the cryogels for C, H, S, and O elements was done. The theoretical and the experimental elemental compositions of p(α-CD), p(β-CD), and p(γ-CD) cryogels were determined. The theoretical crosslinking values of 150%, 100%, and 125% for p(α-CD), p(β-CD), and p(γ-CD) cryogels were determined as 142.04%, 90.85%, and 120.48%, respectively, based on the elemental analysis. Therefore, it was found that the theoretical and experimental crosslinking of p(CD) cryogels regardless of their nature, for example, α-CD, β-CD, and γ-CD are in good agreement, for example, within the 10% limit. Moreover, the crosslinking yield % of p(α-CD), p(β-CD), and p(γ-CD) cryogels were calculated by taking the ratio of experimental crosslinking degree based on S atoms determined from elemental analysis results to the theoretical crosslinking ratio depending on the used amounts of DVS during synthesis. The crosslinking yield % values were determined as 95%, 91%, and 96% for p(α-CD), p(β-CD), and p(γ-CD) cryogels, respectively.

### Example 4. Lithium Recovery Using p(CD)s

Natural water sources such as sea water, salt lake waters, geothermal waters and underground waters with high concentrations of Li-ions can be employed as the resources. The microparticles, superporous cryogels and fibers of p(CE) and p(CD) and their copolymeric formulations can be used as adsorbent for Li-ion via batch and continuous types of process. The water is contacted with the adsorbents at room temperature in a colon or in a tank at certain times, e.g., 2-12 h for the loading of Li-ion into p(CE), or into p(CD) based structures. After loading/adsorption of Li-ion, the adsorbents is treated with low concentrations (0.1-1 M) of acids, such as hydrochloric acid (HCl), citric acid (Cit A), acetic acid (AcA) and collected in storage tanks as highly concentrated Li-ion.

The adsorption studies of Li-ion by p(α-CD), p(β-CD), and p(γ-CD) micro/nanoparticles and cryogels were carried out in 1000 ppm Li-ion solutions. Lithium sulfate (Li₂SO₄) was used as Li-ion sources. The 50 mg CD-based micro-and cryogels (50 mg) were placed into 25 mL 1000 ppm aqueous Li-ion solutions, separately, and stirred at 250 rpm mixing rate for 4 h. Then, the p(CD) micro/nanoparticles were removed from the adsorption medium by centrifugation at 10000 rpm and the amount of Li⁺ in solution was determined by Inductive Coupled Plasma Optical Emission Spectroscopy (ICP-OES). The p(CD) cryogels can be readily removed from the adsorption medium via a spatula as they are bigger in sizes. Table 1 shows the Li-ion adsorption capacity of p(CD) micro/nanoparticles and cryogels.

TABLE 1
The comparison of amount of Li⁺ ions adsorbed
by Cyclodextrin (CD)-based micro- and cryogels.

| | Adsorbed Li⁺ amount (mg/g) | | |
|---|---|---|---|
| Materials | p(α-CD) | p(β-CD) | p(γ-CD) |
| Microgel | 7.8 ± 0.5 | 56.4 ± 2.3 | 6.8 ± 0.6 |
| Cryogel | 3.7 ± 0.2 | 10.6 ± 0.7 | 2.1 ± 0.1 |

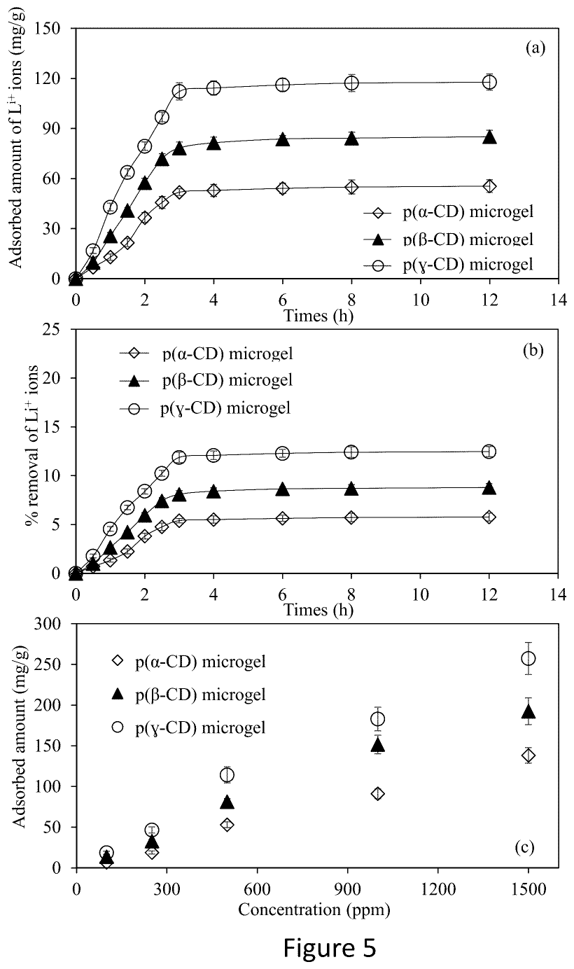

Equilibrium times of Li⁺ ion adsorption by p(CD)-based microgels were determined. FIG. 5, panel (a) shows Li⁺ ion adsorption from 100 mL 500 ppm Li⁺ ion solutions with p(CD)-based microgels as adsorbents. Accordingly, the amount of Li⁺ ions adsorbed by p(α-CD), p(β-CD), and p(γ-CD) microgels reached equilibrium in 4 h. However, the amount of adsorbed Li⁺ ions vary according to the type of p(CD)-based microgels. The p(α-CD), p(β-CD), and p(γ-CD) microgels adsorbed 52.9±3.6, 81.4±3.4, and 114.2±4.2 mg/g Li⁺ ions, respectively. On the other hand, the adsorbed amount of Li⁺ ions by p(α-CD), p(β-CD), and p(γ-CD) microgels were 55.4±3.9, 85.1±3.8, and 117.8±4.9 mg/g at the 12^{th} h. It was observed that the adsorbed amount of Li⁺ ions increased as the internal diameter of CDs increased from α- to γ-CD. This trend could be explained by the size difference between different CDs. It was reported in literature that the internal diameters of α-CD, β-CD, and γ-CDs are 0.53, 0.65, and 0.83 nm, respectively. On the other hand, the atomic radius of Lithium is reported as 0.155 nm, whereas its (+1) ionic radius is 0.59 nm, On the other hand, the internal diameter of β-CD (i.e., 0.65 nm) and the ionic radius of Li⁺ ions (i.e., 0.59 nm) are close in value to each other, which can lead to selective Li⁺ ion removal from aqueous media. The adsorbed amount of Li⁺ metal ions from its aqueous solution by p(α-CD), p(β-CD), and p(γ-CD) microgels at 55.4±3.9, 85.1±3.8, and 117.8±4.9 mg/g respectively are comparable to the values reported by alternative lithium recovery methods in the literature. For example, alternative compositions reported in the literature for lithium recovery include: porous titanium-based LIS nanofibers with 59.1 mg/g, Li/Al-LDHs with 7.26 mg/g, HTO-Am with 23.78 mg/g, spinel Li4Mn5O12 with 5.7 mmol/g, iron-doped lithium titanium oxides with 34.8 mg/g, polygonal MnO₂ polymorphs with 2.43 mmol/g, and biochar-based MnO₂ composites with 62.85 mg/g of Li⁺ ion adsorption capacity.

The % removal of Li⁺ ions by p(α-CD), p(β-CD), and p(γ-CD) microgels from 100 mL 500 ppm aqueous solution were compared in FIG. 5, panel (b). 5.5±0.4, 8.4±0.4, and 12.1±0.4% of Li⁺ ions were removed by 50 mg of p(α-CD), p(β-CD), and p(γ-CD) microgels from 100 mL 500 ppm solutions. The effect of Li⁺ ion concentration in the aqueous medium on the adsorption of Li⁺ ions by p(CD)-based microgels was also studied, and the corresponding graphs are shown in FIG. 5, panel (c). The adsorbed amount of Li⁺ ions by p(α-CD) microgels increased from 6.7±0.9 mg/g to 138.3±9.6 mg/g with an increase of Li⁺ ion concentrations from 100 to 1500 ppm in 100 mL solution. Similarly, p(β-CD) achieved higher Li⁺ ion adsorption, from 13.6±1.1 to 192.5±16.5 mg/g, with an increase of Li⁺ ion concentrations from 100 mL 100 ppm to 1500 ppm. The adsorbed amount of Li⁺ ions from 100 mL 100 ppm and 100 mL 1500 ppm Li⁺ ion solutions by p(γ-CD)were determined as 18.7±1.9, and 257.3±19.8 mg/g, respectively. The increase in metal ion adsorption as the metal ion concentration increases can be explained by the increased molecular interactions between metal ions and adsorbents due to higher metal ion concentration in solutions.

### Adsorption Kinetics and Isotherms

Two of the most widely used kinetic models for adsorption studies, the pseudo-first order and pseudo-second order kinetic models, were applied to Li⁺ ion adsorption to identify the rate and mechanism of adsorption for the p(CD)-based microgels. The values of the kinetic variables of qe, k₁, and k₂ were calculated from the log (qₑ-qₜ) vs t plots for pseudo-first order model, and from the t/qₜ vs t plots for pseudo-second order model. These parameters facilitate the understanding of the adsorption kinetics of Li⁺ ions by p(CD)-based microgels, and the calculated values are given in Table 2. Accordingly, Li⁺ ion adsorption of the p(CD)-based microgels exhibited a better fit to the pseudo-first order model with correlation coefficients (R²) of 0.94 for all p(α-CD), p(β-CD), and p(γ-CD) microgels.

TABLE 2
Adsorption kinetics of Li⁺ ion absorption
by p(CD)-based microgels, and cryogels.

| | | | | | Pseudo-second order | | |
|---|---|---|---|---|---|---|---|
| | Experimental | Pseudo-first order | | | | k₂ | |
| Adsorbent | qe | qe | k₁ | | qe | (g mg⁻¹ | |
| (microgels) | (mg/g) | (mg/g) | (min⁻¹) | R² | (mg/g) | min⁻¹) | R² |
| p(α-CD) | 52.9 ± 3.6 | 57.4 | 0.64 | 0.94 | 75.2 | 0.0003 | 0.87 |
| p(β-CD) | 81.4 ± 3.4 | 83.8 | 0.64 | 0.94 | 181.8 | 0.00005 | 0.11 |
| p(γ-CD) | 114.2 ± 4.2 | 119.3 | 0.72 | 0.94 | 113.6 | 0.0001 | 0.32 |

The theoretical qₑ values for Li⁺ ion adsorbed by p(α-CD), p(β-CD), and p(γ-CD) microgels were calculated respectively as 57.4, 83.8, and 119.3 mg/g for pseudo-first order model, whereas the experimental qe value for the p(α-CD), p(β-CD), and p(γ-CD) microgels were found to be 52.9±3.6, 81.4±3.4, and 114.2±4.2 mg/g for Li⁺ ion adsorption.

To summarize, the pseudo-first order kinetic model can better describe the adsorption behavior of Li⁺ ions by p(CD)-based microgels, evidenced by higher correlation coefficients. The pseudo-first order model described the kinetics of Li⁺ ion adsorption with the p(CD)-based microgels, thus establishing that the adsorption rate happens at an active site at the time, and the external mass transfer process was more effective in controlling the Li⁺ ion adsorption process.

The application of adsorption isotherms is a process that is as necessary as applying the kinetic models to understand the mechanism of the adsorption process. Thus, Langmuir and Freundlich models were applied to Li⁺ ion adsorptions by p(CD)-based microgels. The important parameters for Li⁺ ion adsorption calculated from Langmuir and Freundlich models are listed in Table 3. It is noteworthy that the adsorption of Li⁺ ion adsorptions by p(CD)-based microgels had better fits for the Freundlich model with higher correlation coefficients as shown in Table 3.

TABLE 3
Adsorption isotherms of Li⁺ ion
absorption by p(CD)-based microgels.

| | Langmuir | | | Freundlich | | |
|---|---|---|---|---|---|---|
| Adsorbent | qₘ | K_{L} | | | K_{F} | |
| (microgels) | (mg/g) | (L mg⁻¹) | R² | n | (L g⁻¹)^{1/n} | R² |
| p(α-CD) | 416.7 | 0.0002 | 0.37 | 0.88 | 25.2 | 0.99 |
| p(β-CD) | 5000 | 0.00003 | 0.02 | 0.98 | 7.1 | 0.99 |
| p(γ-CD) | 2000 | 0.0001 | 0.24 | 1.02 | 4.1 | 0.99 |

The n values of the p(α-CD), p(β-CD), and p(γ-CD) microgels obtained from the Freundlich model are 0.88, 0.98, and 1.02, respectively. As such, the n values of the microgels increase as the internal cavity of the CDs increases. Moreover, a decrease in calculated KF values from p(α-CD) (25.2 (L/g)^{1/n}) to p(β-CD) (7.1 (L/g)^{1/n}) and p(γ-CD) (4.1 (L/g)^{1/n}) microgels was observed. The decrease in K_{F} values indicates that the adsorption becomes more heterogeneous.

### Selectivity of p(CD)-Based Microgels to Li⁺ Ion

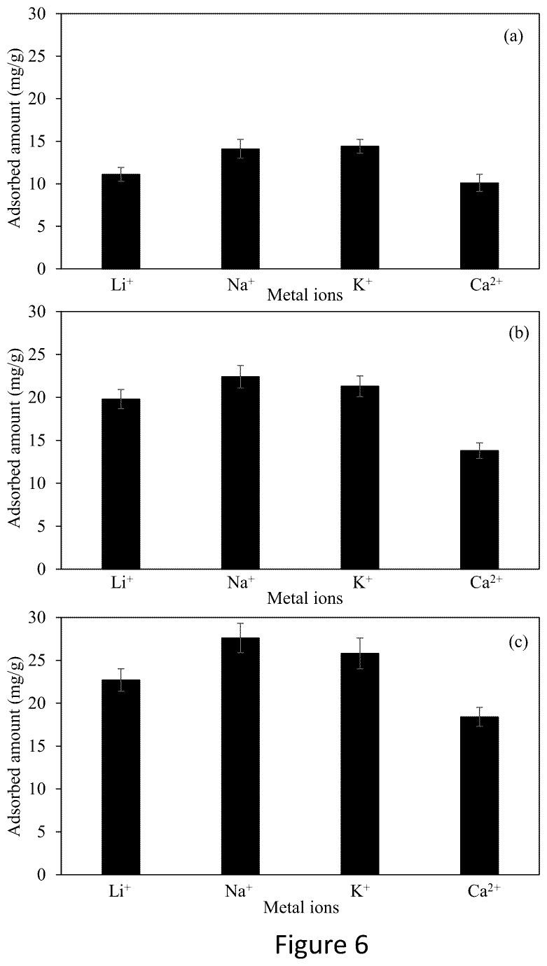

The selectivity studies of p(CD)-based microgels to Li⁺ ion was carried out in the presence of 500 ppm of each Li⁺, Na⁺, K⁺, and Ca²⁺ ions in 100 mL solution. The adsorbed amount of metal ions by p(CD)-based microgels were determined from samples taken from the solution after 4 h (FIG. 6). FIG. 6, panel (a) shows the absorbed amount of Li⁺, Na⁺, K⁺, and Ca²⁺ from 100 mL aqueous solution in the presence of 500 ppm of Li⁺, Na⁺, K⁺, and Ca²⁺ ions by p(α-CD) microgels. 11.1±0.8, 14.1±1.1, 14.4±0.8, and 10.1±1.0 mg/g of Li⁺, Na⁺, K⁺, and Ca²⁺ ions were adsorbed by p(α-CD) microgels in 4 h. The adsorbed amount of Li⁺ ion from the mixture solution decreased by almost 75% comparing to the amount of Li⁺ ions adsorbed from 100 mL 500 ppm pure Li⁺ ion solution (i.e., 52.9±3.6 mg/g).

Similarly, the amount of Li⁺, Na⁺, K⁺, and Ca²⁺ metal ions adsorbed by p(β-CD) microgels were also calculated and shown in FIG. 6, panel (b). The amount of adsorbed Li⁺, Na⁺, K⁺, and Ca²⁺ metal ions by p(β-CD) microgels were calculated as 19.8±1.1, 22.4±1.3, 21.3±1.2, and 13.8±0.9 mg/g, respectively. The amount of Li⁺ ions adsorbed decreased to 19.8+1.1 mg/g in the mixture solution, comparing to the amount of Li⁺ ions adsorbed from 100 mL 500 ppm Li⁺ ion solution (81.4±3.4 mg/g). The adsorbed amount of Li⁺, Na⁺, K⁺, and Ca²⁺ metal ions by p(γ-CD) microgels from their mixture solution was also calculated and compared in FIG. 6, panel (c). The adsorbed amount of metal ions was calculated as 22.7±1.3, 27.6±1.7, 25.8±1.8, and 18.4±1.1 mg/g for Li⁺, Na⁺, K⁺, and Ca²⁺ metal ions, respectively.

Distribution, selectivity, and relative selectivity coefficient values were calculated and summarized in Table 4 for each metal ions and adsorbents, based on the results shown above. The distribution coefficient (K_{d}) is an important parameter to estimate the mobility of compounds in environments. K_{d} is the ratio of solid phase to solute concentrations. High K_{d} values indicate that the bulk of the chemical is adsorbed to the soil surface, making it less likely to move in the soil, but they do not reflect the strength (reversibility) of the sorption. It should be highlighted that this is a macroscopic measurement and only gives indirect information on the sort of surface interactions that are occurring. In Table 4, the calculated K_{d} values for Na⁺ and K⁺ ions are higher than K_{d} values calculated for Li⁺ and Ca²⁺ ions for all p(α-CD), p(β-CD), and p(γ-CD) microgels. Also, the comparison of selectivity coefficients “k”, which indicates the selectivity of adsorbent for target material in the presence of competitor materials, is shown in Table 4. Here, the k values calculated for selectivity between Li⁺/Na⁺, Li⁺/K⁺, and Li⁺/Ca²⁺ metal ions for all p(α-CD), p(β-CD), and p(γ-CD) microgels are summarized in Table 4. p(α-CD), p(β-CD), and p(γ-CD) microgels have slightly higher selectivity for Na⁺ and K⁺ metal ions comparing to Li⁺ metal ions with k values less than 1. On the other hand, selectivity of p(CD)-based microgels for Li⁺ metal ion is higher than Ca²⁺ metal ions with k values greater than 1.

TABLE 4
Distribution, selectivity, and relative selectivity
coefficients of p(CD)-based microgels for the absorption of Li⁺,
Na⁺, K⁺, and Ca²⁺ metal ions.

| | K_{d} | | |
|---|---|---|---|
| | p(α-CD) | p(β-CD) | p(γ-CD) |
| Metal ions | microgels | microgels | microgels |
| Li⁺ | 0.0119 | 0.0203 | 0.0242 |
| Na⁺ | 0.0149 | 0.0234 | 0.0290 |
| K⁺ | 0.0153 | 0.0226 | 0.0266 |
| Ca²⁺ | 0.0109 | 0.0146 | 0.0196 |
| | k | | |
| | p(α-CD) | p(β-CD) | p(γ-CD) |
| Metal ions | microgels | microgels | microgels |
| Li⁺/Na⁺ | 0.797 | 0.867 | 0.835 |
| Li⁺/K⁺ | 0.778 | 0.901 | 0.877 |
| Li⁺/C2²⁺ | 1.089 | 1.388 | 1.237 |

| | k¹ | | |
|---|---|---|---|
| | p(α-CD)/p(β-CD) | p(α-CD)/p(γ-CD) | p(β-CD)/p(γ-CD) |
| Metal ions | microgels | microgels | microgels |
| Li⁺/Na⁺ | 0.919 | 0.954 | 1.039 |
| Li⁺/K⁺ | 0.864 | 0.888 | 1.027 |
| Li⁺/C2²⁺ | 0.785 | 0.881 | 1.122 |

Moreover, the relative selectivity between Li⁺/Na⁺, Li⁺/K⁺, and Li⁺/Ca²⁺ metal ions was compared across the p(α-CD), p(β-CD), and p(γ-CD) microgels, summarized as k¹ values of p(α-CD)/p(β-CD), p(α-CD)/p(γ-CD), and p(β-CD)/p(γ-CD) microgels in Table 4. The selectivity of p(α-CD) microgels for Li⁺ metal ions is lower than both p(β-CD) and p(γ-CD) microgels with k¹ values less than 1. On the other hand, p(β-CD) microgels showed better selectivity for Li⁺ ions than both p(α-CD) and p(γ-CD) microgels with k¹ values greater than 1, which can be explained by the similarity in values between the internal diameter of β-CD and the ionic radius of Li⁺ metal ions.

Overall, p(CD)-based microgels have similar selectivity for Li⁺ ions adsorption with calculated k and k¹ values around 1. However, the results showed that p(β-CD) microgels exhibit higher selectivity for Li⁺ metal ions than p(α-CD) and p(γ-CD) microgels. Therefore, some modifications to p(β-CD) microgels for enhancing selectivity for Li⁺ metal ions were carried out.

### Example 5. p(CD)s Modified With CE

To improve the adsorption capacity and adsorption rate of p(β-CD) micro/nano particles for Li⁺ ions, modifications of micro/nano particles using 2-Hydroxymethyl-12-crown-4 of (β-CD) were performed. The modification of p(β-CD) microgels with 2-Hydroxymethyl-12-crown-4 was carried out in four steps. Firstly, prepared p(β-CD) micro/nano particles were treated with sodium periodate (NaIO₄) to create aldehyde groups on micro/nano particles. In brief, 1 g of p(β-CD) micro/nano particles were placed into 20 mL NaIO₄ solution at 16.5 mg/mL concentration and stirred at 500 rpm for 12 h at room temperature. After that, the p(β-CD) micro/nano particles with aldehyde groups (A-p(β-CD)) were collected by centrifugation, washed 3 times with pure water and once with acetone, and then dried with a heat gun. In the second step, prepared A-p(β-CD) were placed into freshly prepared potassium permanganate (KMnO₄) solution in 20 mL 0.5 M H₂SO₄ at 12.2 mg/mL concentration and stirred for 12 h at room temperature to oxidize the aldehyde groups to carboxylic acids (C-p(β-CD)). The prepared C-p(β-CD) micro/nano particles were washed 5 times with water, once with acetone, and dried with a heat gun. Next, the prepared C-p(β-CD) micro/nano particles were suspended in 20 mL DMSO, 0.5 g of carbonyldiimidazole (CDI) was added to medium and stirred for 4 h in room temperature. Finally, this medium was placed into an oil bath (adjusted to 80° C.) and stirred for 20 h after adding 0.64 g of 2-Hydroxymethyl-12-crown-4. The 2-Hydroxymethyl-12-crown-4 modified p(β-CD) micro/nano particles (M-p(β-CD)) were washed with DMSO twice, water twice, and acetone once to remove unreacted reagents from the microgels. The M-p(β-CD) micro/nano particles were dried using heat gun and stored in closed tubes for further usages.

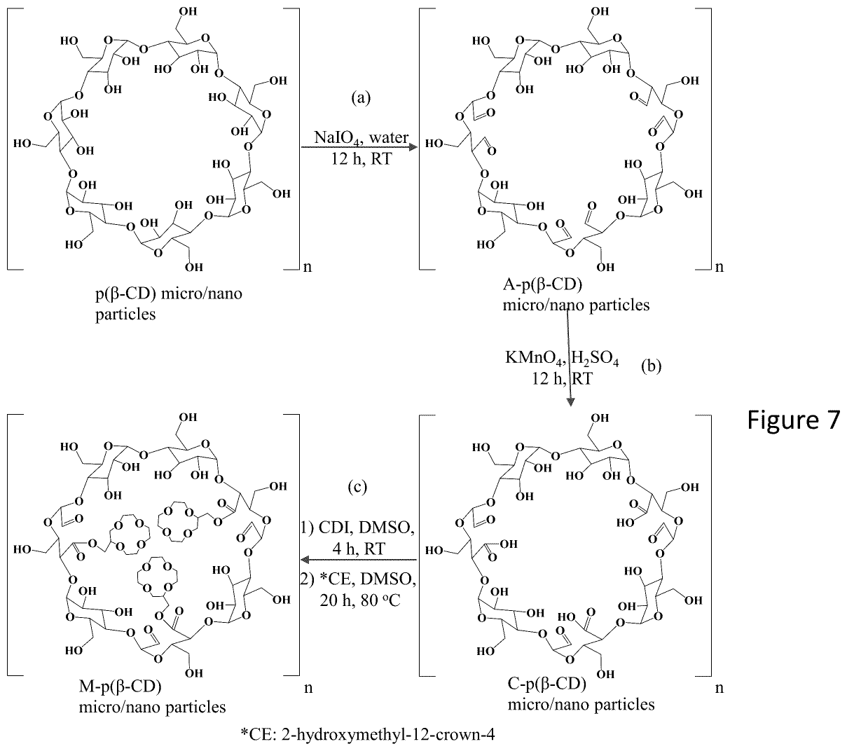

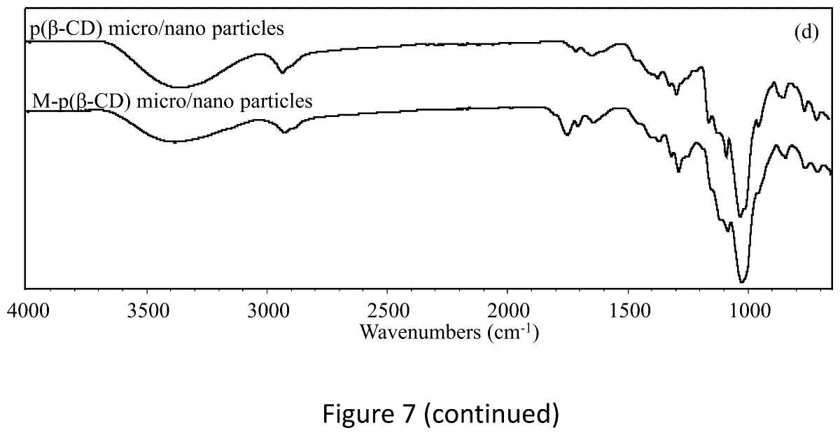

The schematic illustration for modification process of p(β-CD) microgels with 2-Hydroxymethyl-12-crown-4 is given in FIG. 7, steps (a)-(c). In the first step, the p(β-CD) microgels were treated with NaIO₄ to generate aldehyde groups and the schematical presentation is given in FIG. 7, step (a). Aldehyde groups were quickly produced on sugar molecules by chemical treatment with NaIO₄, which allowed for the oxidation of the proximal hydroxyl groups to aldehydes, hence opening the sugar rings. After that, the A-p(β-CD) microgels (white powder) were treated with KMnO₄ in 0.5 M H₂SO₄ to oxidize the aldehyde groups to carboxylic acids, schematical presentation is given in FIG. 7, step (b). Prepared KMnO₄ solution in dilute H₂SO₄ acid was used for oxidation of the aldehydes. During the reaction, the purple color of solution changed to brown color in 2 h, and after 12 h the color of reaction turned to white. Finally, in FIG. 7, step (c), the prepared C-p(β-CD) microgels (white powder) were modified with 2-Hydroxymethyl-12-crown-4 in 2 steps via using a conjugation agent CDI.

In this process one of the molecules may contain a carboxylic acid group and the other one may contain a hydroxyl group. Here, C-p(β-CD) microgels contain carboxylic acid groups, and 2-Hydroxymethyl-12-crown-4 contains hydroxyl groups. Firstly, the prepared C-p(β-CD) microgels were suspended in DMSO and stirred at room temperature for 4 h after adding CDI as conjugation agent. The CDI was reacted with carboxylic acid groups on C-p(β-CD) microgels. In the second step, the mixture was transferred to oil bath adjusted 80° C. and 2-Hydroxymethyl-12-crown-4 was added to reaction medium. The mixture was stirred at 80° C. for 20 h to covalently link 2-Hydroxymethyl-12-crown-4 to C-p(β-CD) microgels.

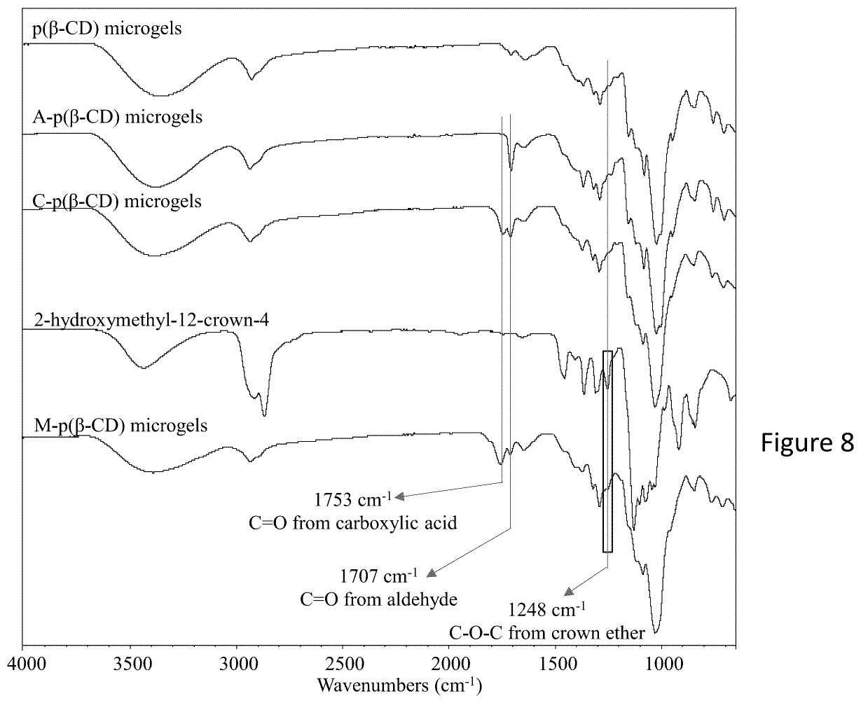

To confirm the successful modification of p(β-CD) micro/nano particles with 2-Hydroxymethyl-12-crown-4 in four steps, the FT-IR spectrum of each material was compared in FIG. 8, and the FT-IR spectrum of bare p(β-CD), and M-p(β-CD) micro/nano particles are shown in FIG. 7, panel (d). In FIG. 7, panel (d), some differences between FT-IR spectrum of bare p(β-CD), and M-p(β-CD) micro/nano particles were observed. The characteristic peaks at 3300-3400 cm⁻¹ for —OH stretching, 2940 cm⁻¹ for symmetric/asymmetric C—H stretching vibrations, between 1120-1250 cm⁻¹ for C—O—C vibration peaks, and 1030 cm⁻¹ for C—O overtone stretching were observed for both p(β-CD), and M-p(β-CD) micro/nano particles. Additionally, the characteristic peaks that appeared at 1022, 1293, and 1361 cm⁻¹ can be assigned to S═O and O—S—O symmetric and asymmetric stretching peaks of sulfone groups on the structure of both p(β-CD) and M-p(β-CD) micro/nano particles. On the other hand, the FT-IR spectrum of A-p(β-CD) shows a distinct peak at 1707 cm⁻¹ which corresponds to C═O peaks from the aldehyde groups. Also, the decrease of peak intensity at 1707 cm⁻¹, and the appearance of a new peak at 1753 cm⁻¹, which can be attributed to the C—O peak of carboxylic acids, was observed in FT-IR spectrum of C-p(β-CD) micro/nano particles. The characteristic C—O—C peaks were also observed from the FT-IR spectra of 2-Hydroxymethyl-12-crown-4 between 1120-1250 cm⁻¹, which are directly overlaid with peaks of p(β-CD) microgels.

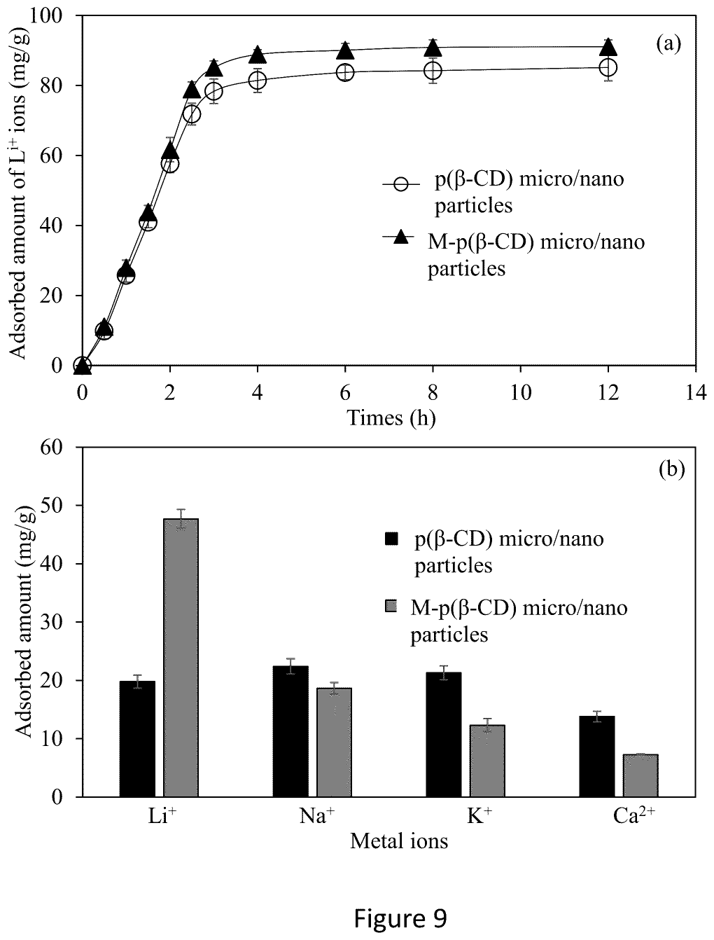

The adsorption capacity and adsorption rate for p(β-CD) micro/nano particles for Li⁺ ions were further studied in (β-CD) micro/nano particles modified with 2-hydroxymethyl-12-crown-4.Li⁺ capacity before and after the modification with 2-hydroxymethyl-12-crown-4 of the (β-CD) micro/nano particles was measured and the corresponding graph is shown in FIG. 9, panel (a). The modification agent 2-Hydroxymethyl-12-crown-4 is specific to Li⁺ ions, and the adsorption capacity and adsorption rate of M-p(β-CD) micro/nano particles were enhanced. In FIG. 9, panel (a), a slight increase was observed on Li⁺ adsorption capacity of p(β-CD) micro/nano particles after modification. The adsorption process of Li⁺ ions by M-p(β-CD) micro/nano particles reached equilibrium in 4 h with an adsorption amount of 88.9±1.3 mg/g. which is almost 10% higher than its unmodified form in the same time period. The adsorbed amount of Li⁺ ions was 91.9±1.9 mg/g after 12 h. The adsorbed amount of Li⁺ ions via 2-Hydroxymethyl-12-crown-4 modified structures were reported in literature as 297 mg/g with crown ether modified chitosan nanofiber membranes, 34.05 mg/g with crown ether moiety containing polyimide membranes, 51.99 mg/g with crown ether functionalized polysulfone membranes, 168.5 mg/g with crown ether grafted graphene oxide/chitosan/polyvinyl alcohol nanofiber membranes, and 4.76 mg/g with crown ether functionalized microporous polyHIPEs, respectively.

Moreover, the comparison of adsorption amount of various metal ions from their mixture solution by both p(β-CD) and M-p(β-CD) micro/nano particles was shown in FIG. 9, panel (b). The concentration of each metal ion was 500 ppm, and the total volume of the mixture solution is 100 mL. The adsorbed amounts of Li⁺, Na⁺, K⁺, and Ca²⁺ ions by p(β-CD) micro/nano particles from their mixture solution in 4 h were calculated as 19.8±1.1, 22.4±1.3, 21.3±1.2, and 13.8±0.9 mg/g, respectively, which are close in value across different ions. On the other hand, the M-p(β-CD) micro/nano particles adsorbed 47.7±1.6, 18.6±1.1, 12.3±1.0, and 7.3±1.3 mg/g of Li⁺, Na⁺, K⁺, and Ca²⁺ metal ions, respectively, from their mixture solution. The amount of Li⁺ ion adsorption by M-p(β-CD) micro/nano particles is higher than the other metal ions in the same mixture solution. This can be considered as a sign that the affinity of p(β-CD) microgel to Li⁺ metal ion increased with the modification process.

The comparison of distribution coefficient (K_{d}), selectivity coefficients (k), and relative selectivity coefficients (k¹) values for p(β-CD), and M-p(β-CD) micro/nano particles were summarized in Table 5. The calculated K_{d} value for M-p(β-CD) microgels for Li⁺ ion is almost 2-fold higher than the calculated K_{d} value for p(β-CD) micro/nano particles.

TABLE 5
The comparison of calculated distribution coefficient (K_{d}),
selectivity coefficients (k), and relative selectivity coefficients
(k¹) for p(β-CD), and M-p(β-CD) micro/nano particles.

K_{d}

| | p(β-CD) | M-p(β-CD) |
|---|---|---|
| | micro/nano | micro/nano |
| Metal ions | particles | particles |
| Li⁺ | 0.0203 | 0.0528 |
| Na⁺ | 0.0234 | 0.0199 |
| K⁺ | 0.0226 | 0.0129 |
| Ca²⁺ | 0.0146 | 0.0075 |

k

| | p(β-CD) | M-p(β-CD) |
|---|---|---|
| | micro/nano | micro/nano |
| Metal ions | particles | particles |
| Li⁺/Na⁺ | 0.867 | 2.650 |
| Li⁺/K⁺ | 0.901 | 4.085 |
| Li⁺/Ca²⁺ | 1.388 | 7.053 |

| | k¹ |
|---|---|
| | p(β-CD)/M-p(β-CD) |
| Metal ions | micro/nano particles |
| Li⁺/Na⁺ | 0.327 |
| Li⁺/K⁺ | 0.220 |
| Li⁺/Ca²⁺ | 0.197 |

Calculated K_{d} values for Na⁺, K⁺, and Ca²⁺ values for M-p(β-CD) micro/nano particles are lower than p(β-CD) micro/nano particles. The adsorption of Li⁺ ions by M-p(β-CD) micro/nano particles is higher than other metal ions in the same mixture solution. Moreover, the selectivity of M-p(β-CD) micro/nano particles for Li⁺ metal ions is higher compared to the competing metal ion species in the same mixture solution, evidenced by the calculated k values. According to the calculated k values of 2.650, 4.085, and 7.053 for Li⁺/Na⁺, Li⁺/K⁺, and Li⁺/Ca²⁺ metal ions, M-p(β-CD) micro/nano particles show almost 2.6-, 4.1-, and 7.0-fold selectivity for Li⁺ ions compared to Na⁺, K⁺, and Ca²⁺ metal ions. Moreover, the calculated k¹ values showed that M-p(β-CD) micro/nano particles display almost 3.1-, 4.5-, and 5.1-fold selectivity compared to p(β-CD) micro/nano particles for Li⁺ ions.

In summary, p(α-CD), p(β-CD), and p(γ-CD) microgels, which are cyclodextrin oligosaccharides, were successfully evaluated for their use in Li⁺ ion adsorption from aqueous media. The results showed that all p(α-CD), p(β-CD), and p(γ-CD) microgels exhibited comparable Li⁺ ion adsorption amounts from 100 mL 500 ppm aqueous solution in 12 h, at 55.4±3.9, 85.1±3.8, and 117.8±4.9 mg/g, respectively. Although the selectivity of these microgels for Li⁺ ions in the presence of Na⁺, K⁺, and Ca²⁺ ions was mediocre, p(β-CD) microgels has the highest relative selectivity among p(α-CD), p(β-CD), and p(γ-CD) microgels. The reason for this may be that the ionic diameter of Li⁺ (0.59 nm) and the internal cavity of β-CD (0.65 nm) are close to each other. Therefore, p(β-CD) microgels were modified with 12-crown ether-4, which is specific for Li⁺ ions, to improve selectivity properties. The selectivity coefficients of M-p(β-CD) for Li⁺ ions in the presence of Na⁺, K⁺, and Ca²⁺ were determined as 2.650, 4.085, and 7.053, which are almost 3.1, 4.5, and 5.1 fold of p(β-CD) microgels' selectivity for Li⁺ ions. Therefore, the intended increase in selectivity by modifying the prepared p(β-CD) microgels was successfully achieved. In view of the data obtained, the p(CD)-based microgels prepared have adsorption capacities comparable to the metal-based adsorbents reported many times in the literature. They can bring great industrial advantages due to their features such as being natural and biocompatible. Furthermore, the re-useability of M-p(β-CD) micro/nano particles for Li⁺ recovery from various aquatic medium makes these materials superior in comparison to the other adsorbent.

### Example 6. Experimental Procedure

### Adsorption Kinetics and Adsorption Isotherms

The well-known kinetic models of pseudo-first order (Eq. 1) and pseudo-second order (Eq. 2) models were used for the determination of kinetic parameters such as rate constants and adsorption capacities of the p(CD)-based microgels for Li⁺ ions adsorption studies from aqueous solutions. Moreover, the well-established adsorption isotherms of Langmuir, and Freundlich models were applied to metal ion adsorption studies with p(CD)-based microgels to better characterize Li⁺ ions adsorption mechanisms. The linear Langmuir model expressed by Eq. (3) assumes that there is no adsorbate migration at the surface plane of the adsorbent during the adsorption process assuming uniform adsorption energy.

The linear Freundlich model is based on the principle that surface energies are heterogeneous during the adsorption process. According to the Freundlich model given in Eq (4), as the value of the slope approaches zero, the adsorption becomes more heterogeneous.

$$log ( {q}_{e} - {q}_{t} ) = log {q}_{t} - ( {k}_{1} / 2.303 ) t \qquad ( 1 )$$

$$t / {q}_{t} = 1 / {k}_{2} {q}_{e}^{2} + t / {q}_{e} \qquad ( 2 )$$

$${C}_{e} / {q}_{e} = 1 / {q}_{m} {K}_{L} + {C}_{e} / {q}_{m} \qquad ( 3 )$$

$$ln {q}_{e} = ln {K}_{F} + 1 / n ln {C}_{e} \qquad ( 4 )$$

where “qₑ” and “qₜ” respectively refer to the amounts of adsorbate per unit weight of adsorbent (mg.g⁻¹) at equilibrium and time t, while k₁ and k₂ (min⁻¹) represent the rate constants for pseudo-first and -second order models, respectively. “Cₑ” denotes equilibrium concentration of a given solute in the bulk solution (ppm), “qₘ” is the maximum capacity of adsorption for a given adsorbent (mg.g⁻¹), K_{L} is the Langmuir constant (L.mg⁻¹), “K_{F}” is the Freundlich constant indicating the relative adsorption capacity of the adsorbent (mg^{1-(1/n)}L^{1/n}.g⁻¹), and “n” is a constant denoting the intensity of adsorption.

### Selectivity Studies

The selectivity studies for p(CD)-based microgels were carried out from the mixture of Li⁺, Na⁺, K⁺, and Ca²⁺ solutions. For this purpose, 25 mL 2000 ppm of each Li⁺, Na⁺, K⁺, and Ca²⁺ metal ion solutions were mixed, and 500 ppm Li⁺, Na⁺, K⁺, and Ca²⁺ metal ions contained in 100 mL total solution was prepared. After that, 50 mg of p(α-CD), p(β-CD), p(γ-CD), and M-p(β-CD) microgels were placed to these solutions and stirred for 4 h at room temperature. The adsorbed amounts of metal ions were determined via AAS after required dilutions.

The well-known and important coefficients for absorption studies such distribution (K_{d}), selectivity (k) and relative selectivity (k¹) coefficients were calculated for Li⁺, Na⁺, K⁺, and Ca²⁺ ions (100 mL, 500 ppm) using p(α-CD), p(β-CD), p(γ-CD), M-p(β-CD) microgels using Equations (5)-(7):

$${K}_{d} = ( {q}_{e} / {C}_{e} ) \cdot ( {W}_{adsorbent} / {V}_{adsorbate} ) \qquad ( 5 )$$

where “K_{d}” is the distribution coefficient, “qₑ” is the amount of adsorbate per unit weight of adsorbent (mg/g), and “Cₑ” denotes equilibrium concentration of a given solute in the bulk solution (ppm) of Li⁺, Na⁺, K⁺, and Ca²⁺ ions. W_{adsorbent} is the amount of adsorbent in g and V_{adsorbate} is the volume of the dye solution in L.

$$k = {K}_{d} ( {Li}^{+} ) / {K}_{d} ( {Na}^{+} ) , k = {K}_{d} ( {Li}^{+} ) / {K}_{d} ( {K}^{+} ) , \\ and k = {K}_{d} ( {Li}^{+} ) / {K}_{d} ( {Ca}^{2 +} ) \qquad ( 6 )$$

where “k” is the selectivity coefficient, and “K_{d}” is the distribution coefficient of Li⁺, Na⁺, K⁺, and Ca²⁺ ions.

$${k}^{1} = k ( p ( α - CD ) ) / k ( p ( β - CD ) ) , \qquad ( 7 )$$

$${k}^{1} = k ( p ( α - CD ) ) / k ( p ( γ - CD ) ) ,$$

$${k}^{1} = k ( p ( β - CD ) ) / k ( p ( γ - CD ) ) ,$$

$$and {k}^{1} = k ( p ( β - CD ) ) / k ( M - p ( β - CD ) )$$

where “k” is the relative selectivity coefficient, and “k” is the selectivity coefficient of p(CD)-based microgels.

1. A polymeric material, which comprises:
(A) a copolymer of crown ether and cyclodextrin;
(B) a cryogel of poly-crown ether;
(C) a fiber of poly-crown ether;
(D) a microgel of poly-cyclodextrin;
(E) a cryogel of poly-cyclodextrin;
(F) a fiber of poly-cyclodextrin; or
a combination thereof.

2. The polymeric material of claim 1, comprising (A) a copolymer of crown ether and cyclodextrin, which is:
(A-1) a particle of the copolymer;
(A-2) a cryogel of the copolymer;
(A-3) a fiber of the copolymer, or
a combination thereof.

3. The polymeric material of claim 1, comprising (B) a cryogel of poly-crown ether, which further comprises poly-cyclodextrin particles embedded in the poly-crown ether.

4. The polymeric material of claim 1, comprising (C) a fiber of poly-crown ether, which further comprises poly-cyclodextrin particles embedded in the poly-crown ether.

5. The polymeric material of claim 1, comprising (D) a microgel of poly-cyclodextrin, which is modified by crown ether.

6. The polymeric material of claim 1, comprising (F) a fiber of poly-cyclodextrin, which further comprises poly-crown ether particles embedded in the poly-cyclodextrin.

7. The polymeric material of claim 1, wherein the crown ether is 12-crown-4 ether, 15-crown-5, 18-crown-6, or a derivative thereof.

8. The polymeric material of claim 1, wherein the cyclodextrin is α-cyclodextrin, β-cyclodextrin, γ-cyclodextrin, or a derivative thereof.

9. The polymeric material of claim 5, wherein the microgel comprises poly-β-cyclodextrin modified by 12-crown-4 ether.

10. The polymeric material of claim 9, wherein the microgel comprises a repeating unit of

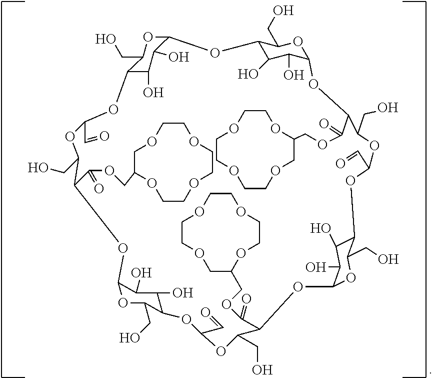

11. The polymeric material of claim 1, wherein the crown ether or the cyclodextrin repeating units are crosslinked by a crosslinker to form the copolymer of crown ether and cyclodextrin, the poly-crown ether, or the poly-cyclodextrin, wherein the crosslinker is methylene bis Acrylamide (MBA), divinylbenzene (DVB), divinyl sulfone (DVS), or a combination thereof.

12. (canceled)

13. A method of preparing a modified poly-cyclodextrin, comprising:
converting a poly-cyclodextrin to an intermediate, wherein at least one cyclodextrin unit of the intermediate has a moiety of 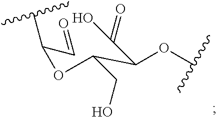 [SMILES: *OC(C(=O)O)C(CO)OC(*)C=O]
reacting the intermediate with a crown-ether derivative having a —OH group to produce the modified poly-cyclodextrin, where at least one cyclodextrin unit of the modified poly-cyclodextrin has a moiety of 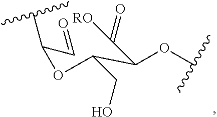
wherein R is the remainder of crown-ether derivative.

14. The method of claim 13, wherein the poly cyclodextrin is poly-α-cyclodextrin, poly-β-cyclodextrin, poly-γ-cyclodextrin, or a derivative thereof.

15. The method of claim 13, wherein the crown ether derivative is a derivative of 12-crown-4, a derivative of 15-crown-5, or a derivative of 18-crown-6.

16. The method of claim 13, wherein converting the poly-cyclodextrin to the intermediate comprises treating the poly-cyclodextrin with an oxidizing agent.

17. (canceled)

18. A modified poly cyclodextrin produced by the method of claim 13.

19. (canceled)

20. A method of recovering lithium ions from an aquatic source, the method comprises
contacting the aquatic source with the polymeric material of claim 1, whereby the lithium ions form a complex with the polymeric material; and
isolating lithium ions from the complex.

21. The method of claim 20, further comprising treating the complex with an acid prior to isolating lithium ions from the complex.

22. (canceled)

23. (canceled)

24. (canceled)

25. (canceled)

26. The method of claim 20, wherein the aquatic source comprises sea water, lake water, geothermal water, underground water, a lithium solution, or a combination thereof.

27. The method of claim 20, wherein the concentration of lithium ions in the aquatic source is about 100 ppm to about 2000 ppm.
